(19) United States
(12) Patent Application Publication
(10) Pub. No.: US 2010/0026210 A1
(43) Pub. Date: Feb. 4, 2010

(54) APPARATUS FOR DRIVING A GAS DISCHARGE LAMP

(75) Inventors: Robertus Antonius Johannes Keijser, Eindhoven (NL); Jerzy Janczak, Rosemont, IL (US); Ronald Edwin Lavooi, Eindhoven (NL); Bennie Simpelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/526,088

(22) PCT Filed: Feb. 11, 2008
(86) PCT No.: PCT/IB08/50487

§ 371 Date: Aug. 6, 2009

(30) Foreign Application Priority Data
Feb. 13, 2007 (EP) 07102245.3

(51) Int. Cl. H05B 41/36

(52) U.S. Cl. 315/302

(57) ABSTRACT

A driver (10) for driving a gas discharge lamp (L) comprises a current generator (1; 2) for generating a lamp current with a main lamp current component and, for arc-straightening purposes, a ripple current component. A controller (3) controls the current generator such as to set the ripple frequency (f_{R}) and ripple amplitude (M). A memory (5) contains data defining a set point (SP) for the ripple frequency and ripple amplitude. A measuring device (4) provides at least one measuring signal indicative of arc curvature and arc stability. The controller is capable of operating in a ripple optimization mode in which the controller makes small adjustments to the ripple frequency and ripple amplitude to find improved arc-straightening, and, if such improvement is found, controls the current generator on the basis of the adjusted set point or otherwise resumes operation on the basis of the original set point (SP) in the memory (5).

### FIELD OF THE INVENTION

The present invention relates in general to gas discharge lamps, more particularly high-pressure or high intensity discharge lamps.

### BACKGROUND OF THE INVENTION

When a gas discharge lamp is operated in a horizontal position, it is known that the problem arises that the arc may take a curved shape due to, among others, gravity and convection, and it is further known that the application of a high-frequency current component can have the result of straightening the arc; for instance, reference is made to U.S. Pat. No. 5,436,533 and EP-0713352. For some lamp types, it is advantageous if the high-frequency is swept.

A problem is that the exact frequencies that achieve arc straightening are not the same for different lamp types, and are not even necessarily the same for different lamps of the same type, for instance due to production tolerances, differences in lamp orientation, ageing, etc. Further, a problem is that a high-frequency current component may give rise to acoustic resonances, which is undesirable because it may lead to light flicker, arc distortion, and eventually failure of the arc tube. A further complicating factor is that the exact resonance frequencies may vary for different lamp types and even for different lamps of the same type. Thus, it is problematic to design a lamp driver, adapted to add a high-frequency current ripple, such that the current ripple frequency under all circumstances is advantageous with a view to arc-straightening without being disadvantageous with a view to resonances.

### SUMMARY OF THE INVENTION

It is an objective of the present invention to overcome or at least reduce the above problems.

According to an important aspect of the present invention, arc straightness and arc stability are monitored, preferably by sensing an electric parameter or an optical parameter. On the basis of the measurement data, ripple frequency and/or ripple amplitude are adapted to obtain an optimum setting. This setting is stored in a memory, and used as starting point for a subsequent power-up.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically showing an electronic driver for driving a gas discharge lamp;

FIG. 2 is a graph showing the results of an experiment;

FIG. 3 is a flow diagram schematically illustrating adaptive operation of a lamp driver.

### DETAILED DESCRIPTION OF THE INVENTION

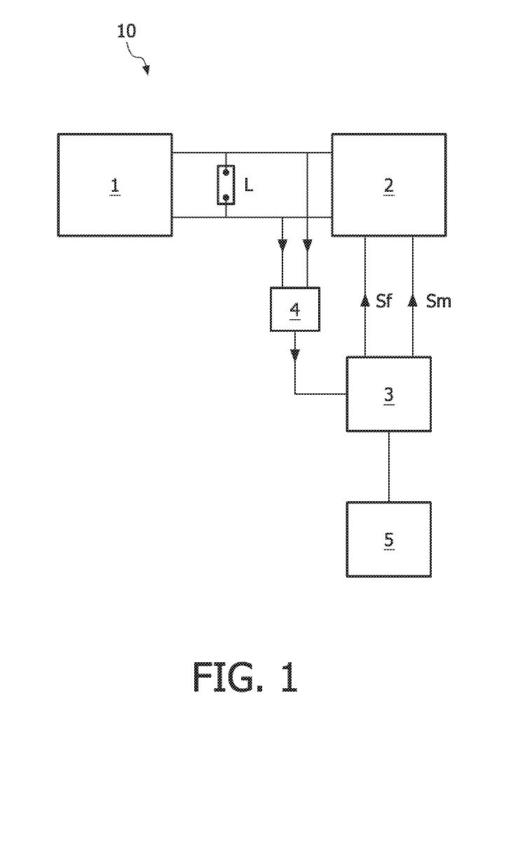

FIG. 1 is a block diagram schematically showing an electronic driver 10 for driving a gas discharge lamp L. The lamp L is of a type having two electrodes opposite each other in a sealed chamber. During operation, a discharge is maintained within the chamber, which discharge is indicated as an electric arc. It is a problem that the electrical arc can take a curved shape (“bowing” of the arc). This may occur in horizontal operation, i.e. where the arc is directed horizontally, in which case bowing is mainly due to convection. Bowing may also occur in vertical operation, in which case bowing can occur due to Lorentz forces of the lamp construction. The tendency of the arc taking a curved shape involves the risk that the arc touches the wall of the chamber. In both situations, horizontal operation as well as vertical operation, arc straightening is a solution for longer lamp life and/or for obtaining better technical properties of the lamp. Since gas discharge lamps as well as the problem of arc curving are known per se, a more detailed explanation is omitted here.

The driver 10 comprises a first current generator 1, which in the following will also be indicated as main current generator. The expression current generator is used in this description and claims in the sense of a source providing a current at respective output terminals substantially independent of the voltage between these terminals. Ideally the current source has zero internal admittance. This main current generator has output terminals coupled to the lamp electrodes, and provides the main or basic lamp current. Depending on, for instance, lamp type, type of application of the lamp, designer's preference, etc, this main lamp current may be a DC current, a commutating DC current, a sine-shaped current, a triangular current, etc. In the case of a commutating DC current, the duty cycle may be 50% but it is also possible that the duty cycle is varied. The choice of the waveform of the main lamp current is not relevant for understanding the present invention. Since current generators for generating lamp current having a desired waveform are known per se, a detailed discussion of design and operation of the main current generator 1 is omitted here.

The driver 10 in this example also comprises a second current generator 2, which in the following will also be indicated as secondary current generator. This secondary current generator, which provides a sine-shaped secondary current that will also be indicated as “ripple current”, has output terminals coupled to the lamp electrodes in parallel to the output terminals of the main current generator 1, so that the lamp L receives the summation of the main lamp current from the main current generator 1 and the ripple current from the secondary current generator 2.

With two current generators connected in parallel, two waveforms having different frequencies can be added to obtain a sum signal. The main current can be relatively low-frequency with respect to the ripple frequency. Particularly, the main current may be square wave, in which case the sum-current is a square wave with a ripple superimposed thereon. It is also possible that the main current is relatively high-frequency with respect to the ripple frequency; particularly, the main current may be a VHF current.

It is noted that, instead of two separate current generators connected in parallel, different designs are possible. For instance, instead of a parallel connection of the current generators, a series connection is possible. Further, the two current generators may be integrated; this specifically makes it possible to generate the lamp current as a modulated waveform, for instance a VHF carrier amplitude-modulated with the ripple frequency. Further, instead of a parallel connection of the output terminals, it is also possible that a coupling transformer is used. In any case, functionally, the two current distributions are considered separately, so, for the sake of convenience, two separate current generators connected in parallel are shown.

The ripple current has the purpose of straightening the arc. It is noted that the use of a ripple current for arc straightening purposes is known per se, and that current generators capable of generating a ripple lamp current for arc straightening purposes are known per se. Therefore, a detailed discussion of design and operation of the secondary current generator 2 is omitted here.

The secondary current generator 2 is a controllable current generator, and the driver 10 further comprises a controller 3 for controlling the secondary controlled current generator 2. It is possible that the main current generator 1 also is a controllable current source, and that the controller 3 also controls one or more characteristics of the main controlled current generator 1, but in the exemplary embodiment discussed here, the main current generator 1 has a fixed setting. In the exemplary embodiment of this discussion, the main current may be a commutating DC current, in which case the commutation frequency and the current magnitude are fixed. Typically, the commutation frequency may be in the range of 50 Hz-10 kHz, while a commutation frequency in the order of about 100 Hz is common. Depending on the lamp type, a typical lamp current magnitude is in the order of about 1 A. A typical lamp voltage is in the order of about 100 V.

As regards the ripple current, this typically has a ripple frequency in the range from 1 kHz to 100 kHz, the actual ripple frequency being dependent on a control signal Sf from the controller 3. The amplitude of the ripple current is expressed as a modulation depth M, defined as the amplitude of the ripple current divided by the amplitude of the main current. Typically, the modulation depth M is in the range from 0 to 40%, the actual modulation depth being dependent on a control signal Sm from the controller 3.

Apart from ripple frequency and modulation depth, the ripple current may have some further characteristic features. For instance, the frequency of the ripple current may be swept in a sweep range from a lower frequency limit to an upper frequency limit, in which case the sweep frequency, the sweep range, the sweep form (triangular, sine-shaped, etc) are further parameters. In principle, it is possible that these parameters are also controlled by the controller 3, in which case an optimization with respect to these parameters can also be executed by the controller 3, said optimization being similar to the optimization that will be discussed in the following. However, in the embodiment that is preferred in view of its design simplicity, the parameters as mentioned are fixed in accordance with predetermined design considerations. It is noted that these parameters may have an influence on the eventual setting of the controller 3, in the sense that a different setting of said fixed parameters may lead to a different control setting by the controller 3, but said fixed parameters are no input parameters to the controller; they are taken for granted. In the following discussion, therefore, said fixed parameters will be ignored.

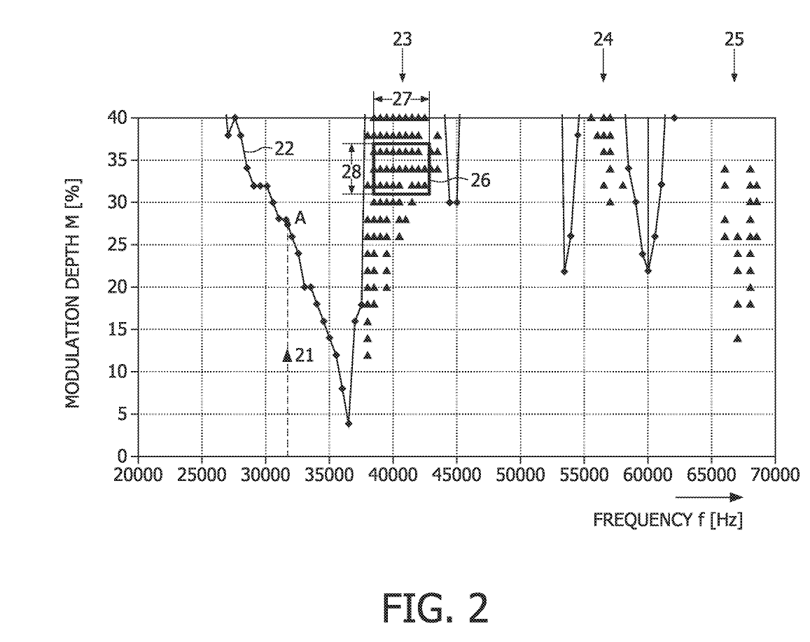

The influence of a ripple current depends on the ripple frequency and modulation depth in a complicated way, as will be illustrated with reference to FIG. 2. FIG. 2 is a graph showing the results of an experiment conducted with one typical gas discharge lamp. This lamp was a 70 W ceramic metal halide lamp. The lamp was operated with a commutating DC current, 50% duty cycle, commutation frequency 90 Hz, current magnitude 0.7 A. On this main current, a ripple current was modulated, of which the frequency and modulation depth were varied. The horizontal axis of FIG. 2 represents the ripple frequency f_{R}, and the vertical axis of FIG. 2 represents the modulation depth M. The graph illustrates the behavior of the lamp.

The experiment was conducted as follows.

First, the lamp was positioned in a horizontal orientation, resulting in a curved arc. The lamp voltage without ripple current will be indicated as basic lamp voltage V0; for the lamp of this experiment, the basic lamp voltage V0 was equal to 103 V.

Then, a certain ripple frequency was chosen. At this ripple frequency, the modulation depth M was initially set to zero and was then gradually increased in steps of 1%, while the lamp power was maintained constant. Thus, a measuring path was traveled at constant ripple frequency, i.e. a vertical line in FIG. 2, such as for instance line 21. In each measuring point, the behavior of the lamp arc was monitored visually, and also the arc straightening and the arc stability were measured quantitatively.

As an objective parameter indicative of the arc straightening, the lamp voltage V(f_{R},M) was monitored. The lamp voltage is proportional to the arc length, and a curved arc has a greater length than a straight arc; for the lamp of this experiment, the lamp voltage in the case of a straight arc was equal to 100 V. Thus, the reduction in lamp voltage, expressed as ΔV(f_{R},M)=V0−V(f_{R},M), is a measure of the arc straightening. It is also possible to take the relative voltage reduction ΔV_{R}(f_{R},M)=ΔV(f_{R},M)/V0. It is noted that the arc straightening can also be measured in a different way, for instance by optically detecting the actual position of the centre of the arc. Also, instead of using the lamp voltage, it is possible to take the lamp current into account for calculating the impedance of the lamp, and to use the impedance as an indicative parameter.

As an objective parameter indicative of the arc stability, again the lamp voltage V(f_{R},M) was monitored. The lamp voltage was measured several times, and the standard deviation σ(V) of the measured voltages was calculated. In the case of a stable arc, the lamp voltage is constant and σ is equal to zero. A value of σ larger than zero indicates variation of the arc length and hence instability. It is noted that the arc stability can also be measured in a different way, for instance by optically detecting displacement of the centre of the arc, or by optically detecting variations in the light intensity. Also, instead of only taking variations of the lamp voltage into account, it is possible to take the lamp current into account for calculating arc conductivity, and to use variations of the arc conductivity as an indicative parameter. In the experiment, also the visual observation of the lamp gave a good indication of the stability.

Instability leads, among other things, to visual flicker, therefore excessive instability is unacceptable. In the experiment, an instability causing a standard deviation σ(V) of the measured voltages of 2% was considered unacceptable. It should be clear that other experimenters may use different conditions of acceptability.

In the experiment, it appeared that there are frequencies which do not lead to substantial arc straightening. When following a vertical measuring path 21 of measuring points, at such a frequency, eventually, a point is reached where the instability or arc bowing is found to be unacceptable, such as point A on line 21. The measurement was discontinued at this point, i.e. further measurements at higher modulation depth were not performed.

The above was repeated for many frequency values. Curve 22 indicates the collection of points where the instability or arc bowing was found to be unacceptable, these points being indicated as a diamond. This curve will be termed “the acceptability border”. This curve might also be termed “stability border”, indicating that the lamp is stable when operated below the line 22. From the Figure, it can be seen that there are frequency areas where even a small ripple will lead to instability, caused by acoustic resonances. The dip at 37 kHz corresponds to the first azimuthal resonance mode. The first radial resonance mode for this lamp was located at around 80 kHz, which is just outside the scale of FIG. 2.

In the experiment, there were also found measuring points where substantial arc straightening occurred. Arc straightening was considered to be substantial if the relative voltage reduction ΔV_{R}(f_{R},M) was higher than 2%. It should be clear that other experimenters may use different thresholds for considering whether or not arc straightening is substantial.

The individual measuring points where substantial arc straightening was observed are indicated as triangles in the graph. It can be seen that they are grouped in clusters 23, 24, 25.

Having thus analyzed the lamp behavior, specifically the response to a ripple current with frequency fR and modulation depth M, an operator can define an operational window for the ripple current parameters. A suggestion for such an operational window 26 is shown in FIG. 2. The shape of such an operational window may be circular or elliptic, or any other suitable shape. For the sake of simplicity, the shape of the operational window 26 is chosen to be rectangular. In that case, the operational window 26 corresponds to an operational frequency range 27 and an operational modulation range 28, which are independent of each other. An operational set point SP may be defined as the centre of the operational window 26.

For understanding the present invention, the exact shape of the acceptability border 22 is not essential, nor is the exact shape and location of the clusters 23, 24, 25 with substantial arc straightening. In fact, those positions and shapes may vary with lamp orientation, ageing, etc. Nevertheless, by and large, all lamps of the same lamp type have similar acceptability borders and arc straightening clusters. Thus, it is possible to define an operational window 26 and an operational set point SP, in advance, for a specific lamp type, on the basis of experiments performed on one specimen of such a lamp type. Of course, it is advisable to repeat the measurements for several specimens of the same lamp type.

Further, for different lamp types, the shapes of the acceptability borders will be different. Nevertheless, there will be similarities with the graph of FIG. 2, and for most lamp types, if not all, it will be possible to define an operational window 26 and an operational set point SP, although for different lamp types the location and sizes of such windows may be different.

Referring again to FIG. 1, the controller 3 is provided with a non-volatile memory 5 containing data defining the operational window 26 for the lamp L, and containing data defining the operational set point SP for the lamp L. These data are determined and written into the memory 5 by the manufacturer of the driver 10.

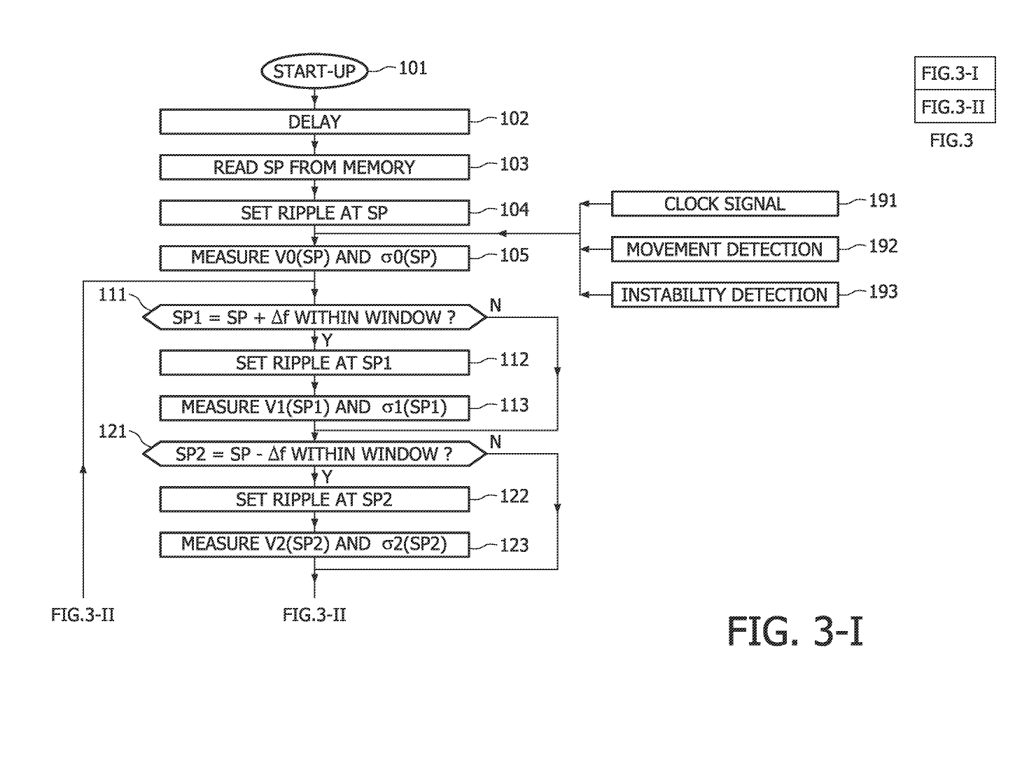

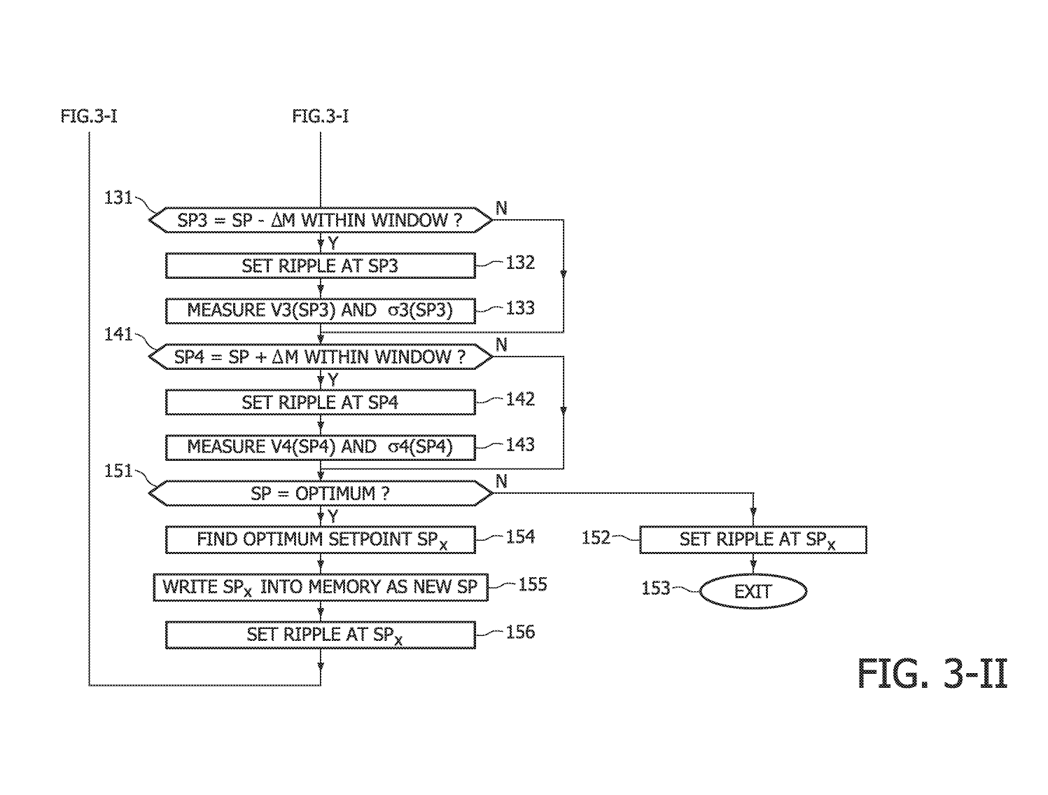

During operation, the controller 3 adaptively controls the secondary current source 2 such as to adaptively set the ripple current to an optimum setting. FIG. 3 is a flow diagram schematically illustrating this adaptive operation.

On start-up (step 101), the controller 3 first allows the lamp L to reach a steady state without ripple frequency (step 102). This can be done by detecting the steady state or by simply waiting a predetermined time. Then, in step 103, the controller 3 reads the set point data for the frequency and modulation depth of the set point SP from memory 5, and sets (step 104) its control signals Sp and Sm for the secondary current source 2 such as to have the secondary current source 2 generate the ripple current with frequency and modulation depth corresponding to the set point SP. It is preferred that the lamp is operated at constant lamp power.

It is noted that this set point SP is within the operational window 26, so this setting already offers an arc straightening effect. However, the effect may not be optimal. Therefore, the controller 3 now enters a ripple optimization mode. In the set point SP, the controller 3 determines (step 105) a qualitative value representing the arc straightness, as well as a qualitative value representing the arc stability. As mentioned earlier, arc straightness and arc stability can be represented and measured in several ways. In a relatively simple and therefore preferred embodiment, the driver 10 comprises a voltage sensor 4 for sensing the lamp voltage V, having its output coupled to the controller 3, while the controller 3 takes the lamp voltage V as a measure for the arc length and therefore the arc straightness and takes the stability of the lamp voltage V (standard deviation σ of multiple measurements) as a measure for the arc stability. The lamp voltage in the set point SP will be indicated as V0(SP), and the standard deviation σ of the lamp voltage in the set point SP will be indicated as σ0(SP). The number of measurements performed for calculating the standard deviation σ is not critical, but is preferably at least equal to 5.

Then, the controller 3 calculates a neighboring set point SP1 having frequency f1=f0+Δf and having the same modulation depth M as the original set point SP, i.e. by taking a predetermined frequency step +Δf. The controller 3 checks (step 111) whether this neighboring set point SP1 still lies within the operational window 26; if so, the controller 3 changes its control signals for the secondary current generator 2 so that the lamp L is operated in this neighboring set point SP1 (step 112), and measures the lamp voltage V1(SP1) and the standard deviation σ1(SP1) (step 113).

Likewise, the controller changes the setting by decreasing the frequency with a predetermined frequency step −Δf to reach a neighboring set point SP2 and measures the lamp voltage V2(SP2) and the standard deviation σ2(SP2) (steps 121-123).

Likewise, the controller changes the setting by decreasing the modulation depth M with a predetermined frequency step −ΔM to reach a neighboring set point SP3 and measures the lamp voltage V3(SP3) and the standard deviation σ3(SP3) (steps 131-133).

Likewise, the controller changes the setting by decreasing the modulation depth M with a predetermined frequency step +ΔM to reach a neighboring set point SP4 and measures the lamp voltage V4(SP4) and the standard deviation σ4(SP4) (steps 141-143).

Then, the controller 3 compares the measured values of voltage (typically as an average of the multiple measurements) and voltage deviation to find an optimum (step 151). In case set point SP is the optimum setting, the measured voltages V1(SP1), V2(SP2), V3(SP3) and V4(SP4) are equal to or higher than V(SP), and the same applies to the standard deviation. In such a case, no changes are needed; the controller 3 resumes the setting of SP (step 152) and exits the ripple optimization mode (step 153). The controller may jump back to 101, 105 or 191.

In case in one or more of the neighboring set points SP1, SP2, SP3, SP4 the measured voltage V1(SP1), V2(SP2), V3(SP3) or V4(SP4), respectively, is lower than V(SP), indicating improved arc straightening, while the corresponding measured standard deviation σ1(SP1), σ2(SP2), σ3(SP3) or σ4(SP4), respectively, is equal to or lower than σ(SP), the one neighboring set point SPx having the lowest measured voltage Vx(SPx) is determined (step 154) and selected as the new set point SP replacing the previous set point SP. The controller 3 writes the corresponding coordinates f_{R} and M of this new set point SPx into the memory 5 (step 155), changes the setting of the secondary current source to the new set point SPx (step 156), and returns to step 111 to see if further improvement is possible.

In case a neighboring set point has a measured voltage lower than V(SP), indicating improved arc straightening, while the measured standard deviation is higher than σ(SP), indicating a worse stability, the neighboring set point may nevertheless be accepted as the new set point SP replacing the previous set point SP if the new standard deviation (i.e. instability) is below a predefined level.

It is noted that the step sizes Δf and ΔM may be fixed as predetermined values in the software of the controller 3 or stored in the memory 5.

It is further noted that the set point used in step 103 may be a fixed set point that is always the same set point. However, in the preferred embodiment as described, the new set point is stored in the memory 5, so that in the case of the next start-up the set point used previously is used as starting point; in this way, changed settings due to ageing or the like are automatically taken into account on start-up.

The above-described ripple optimization procedure may be performed on power-up only, with the ripple setting being maintained constant afterwards until power down. This may be suitable for lamps that are fixedly mounted and switched on/off at least once per day, for instance lamps in office lighting. However, the ripple optimization procedure may also be performed later during operation. For instance, it is possible that the ripple optimization procedure is performed regularly, for instance once every 10 seconds; this may be suitable for lamps that are movable. This is illustrated in FIG. 3 as the controller entering the ripple optimization mode in response to a clock signal (step 191).

It is further possible that the lamp L is provided with a movement detector or optical sensor such as a light cell, and that the controller enters the ripple optimization mode in response to a movement detector signal or optical sensor output signal (step 192).

It is further possible that a stability parameter is monitored (for instance σ(V)), and that the controller enters the ripple optimization mode in response to a detected increase in the stability parameter (increased instability) to a level above a predefined level (step 193).

Summarizing, the present invention provides a driver 10 for driving a gas discharge lamp L, which comprises a current source 1; 2 for generating a lamp current with a main lamp current component and, for arc-straightening purposes, a ripple current component. A controller 3 controls the current source such as to set the ripple frequency f_{R} and ripple amplitude M. A memory 5 contains data defining a set point SP for the ripple frequency and ripple amplitude. A measuring device 4 provides at least one measuring signal indicative of arc curvature and arc stability.

The controller is capable of operating in a ripple optimization mode in which the controller makes small adjustments to the ripple frequency and ripple amplitude to find improved arc-straightening, and, if such improvement is found, controls the current source on the basis of the adjusted set point or otherwise resumes operation on the basis of the original set point SP in the memory 5.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, in the above examples the lamp is operated with low-frequency square-wave current, in which case the ripple frequency is higher than the main frequency. However, it is also possible that the main current is a VHF current, with a main frequency in the order of 100 kHz-2 MHz, in which case the frequency of the secondary current is lower than the main frequency. In such a case, the lamp current can be obtained by amplitude modulation of the main current; nevertheless, for the sake of simplicity, for this situation the phrase “ripple” will also be used.

Further, in the exemplary embodiment, the sensor 4 only gives a lamp voltage reading, and the controller calculates a voltage deviation. It is also possible that the sensor itself generates output signals directly representing arc length and arc stability to be received by the controller.

Further, in the exemplary embodiment, the data defining the window 26 are stored in the memory 5. It is also possible, for instance, that these data are incorporated in the controller software.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such a functional block is performed by individual hardware components, but it is also possible that one or more of these functional blocks are implemented in software, so that the function of such a functional block is performed by one or more program lines of a computer program or a programmable device such as a microprocessor, microcontroller, digital signal processor, etc.

1. Driver for driving a gas discharge lamp (L) generating an arc having a curvature and stability, the driver comprising:
a current generator for generating a lamp current with a main lamp current component in a first frequency range and a ripple current component in a second frequency range differing from the first frequency range;
a controller generating control signals (Sf, Sm) for controlling the current generator to set the ripple frequency (f_{R}) and ripple amplitude (M);
a memory containing data defining an original set point (SP) for the ripple frequency (f_{R}) and ripple amplitude (M);
at least one measuring device for providing at least one measuring signal indicative of arc curvature and arc stability;
wherein, upon start up, the controller sets the ripple frequency (f_{R}) and ripple amplitude (M) based at least in part on the data in the memory;
and wherein the controller (3) is operable in a ripple optimization mode in which the controller adjusts at least one of the ripple frequency (f_{R}) and ripple amplitude (M), and, if such adjustment results in a reduced arc curvature, controls the current source on the basis of the adjusted set point (SPx) or otherwise resumes operation on the basis of the original set point (SP) in the memory.

2. Driver according to claim 1, wherein the controller is designed, if said adjustment results in the reduced arc curvature, to store data defining the adjusted set point (SPx) into the memory (5).

3. Driver according to claim 1, wherein the controller is designed to enter the ripple optimization mode immediately on the start-up.

4. (canceled)

5. Driver according to claim 1, further comprising a lamp movement detector, wherein the controller is designed to enter the ripple optimization mode in response to a detection of movement of the lamp.

6. Driver according to claim 1, wherein the controller is designed to enter the ripple optimization mode in response to a detection of instability of the lamp.

7. Driver according to claim 1, wherein the controller is designed to enter the ripple optimization mode in response to a clock signal to regularly perform the ripple optimization procedure.

8. Driver according to claim 1, wherein the controller is provided with information defining an operational window (26) for the ripple set point (SP), and wherein the controller is designed, when performing the ripple optimization procedure, to assure that the ripple set point (SP) stays within said operational window.

9. Driver according to claim 1, wherein the controller is designed, during the ripple optimization procedure, to independently vary the ripple frequency (f_{R}+Δf, f_{R}−Δf) and the ripple amplitude (M−ΔM, M+ΔM) and to measure the corresponding values of said measuring signal to find a reduced arc curvature and/or improved arc stability.

10. Driver according to claim 1, wherein the measuring device comprises a voltage sensor having input terminals connected to sense lamp voltage;
wherein the controller takes the sensor output signal (V) as representing arc curvature;
and wherein the controller is operative to take a series of multiple lamp voltage measurements, to calculate a deviation (σ) of the measured lamp voltage readings, and to take this deviation (σ) as representing arc stability.

11. Driver according to claim 1, wherein the measuring device comprises a voltage sensor having input terminals connected to sense lamp voltage;
wherein the controller takes the sensor output signal (V) in combination with the lamp current for calculating arc conductivity as representing arc curvature;
and wherein the controller is operative to take a series of multiple measurements of arc conductivity, to calculate a deviation (σ) of the measured arc conductivity readings, and to take this deviation (σ) as representing arc stability.

12. Driver according to claim 1, wherein the measuring device comprises an optical sensor arranged for optically monitoring the arc;
and wherein the controller is operative to take a series of multiple optical sensor measurements, to calculate a deviation (σ) of the measured optical sensor readings, and to take this deviation (σ) as representing arc stability.

13. Driver according to claim 1, wherein the main current component is DC current.

14. Driver according to claim 1, wherein the main current component is commutating DC current.

15. Driver according to claim 1, wherein the main current component is AC current.

16. Driver according to claim 14, wherein the main current component has a frequency in the range from 50 Hz to 10 kHz.

17. Driver according to claim 14, wherein the main current component has a frequency in the range from 100 kHz to 2 MHz.

18. Driver according to claim 17, wherein the lamp current is generated by amplitude modulation of the main current.

19. Driver according to claim 1, wherein the ripple current component is substantially sine-shaped.

20. Driver according to claim 1, wherein the ripple current component has a frequency in the range from 1 kHz to 100 kHz.
